(19) United States
(12) Patent Application Publication
(10) Pub. No.: US 2026/0365485 A1
(43) Pub. Date: Nov. 19, 2026

(54) ELEVATOR, METHOD FOR INSTALLING ELEVATOR, BUILDING HAVING ELEVATOR, AND METHOD FOR CONSTRUCTING BUILDING

(71) Applicant: HYUNDAI ELEVATOR CO., LTD, Chungcheongbuk-do (KR)

(72) Inventors: Tae Won Lee, Chungcheongbuk-do (KR); Sung Joon Bae, Chungcheongbuk-do (KR); Woo Sung Hwang, Chungcheongbuk-do (KR); Jae Kwang Yu, Chungcheongbuk-do (KR); Dong Hwan Oh, Chungcheongbuk-do (KR); Jung Ho Jung, Chungcheongbuk-do (KR)

(21) Appl. No.: 19/434,595

(22) Filed: Dec. 29, 2025

(30) Foreign Application Priority Data
May 15, 2025 (KR) 10-2025-0063062

(51) Int. Cl. B66B 19/00; B66B 9/00; B66B 13/08; B66B 13/30

(52) U.S. Cl. CPC B66B 19/00; B66B 9/00; B66B 13/08; B66B 13/30

(57) ABSTRACT

According to the present disclosure, a method for constructing a building, may include installing a fastener at a reference location which provides a reference for the correct positioning of elevator components within the building, during the construction of the building; providing the elevator components; and fastening the elevator components to the fastener. The providing the elevator components can be done independently of constructing the building.

### CROSS-REFERENCE TO RELATED APPLICATIONS

This application is based on and claims priority under 35 U.S.C. § 119 to Korean Patent Application No. 10-2025-0063062 filed on May 15, 2025, with the Korean Intellectual Property Office, the disclosure of which is incorporated by reference herein in its entirety.

The present disclosure relates to an elevator, a method for installing an elevator, a building having an elevator, and a method for constructing a building.

Technological advancements related to elevators are occurring rapidly. Elevators are advancing in step with the trend toward high-speed operation, high efficiency, eco-friendliness, and smarter operation. One example of this technological advancement is the modular elevator. Unlike conventional elevators, the modular elevators are machine-room-less (MRL) elevators, with their drive, control, and safety systems assembled as individual modules within the hoist way. The modular elevators are manufactured in advance by modularizing components at the elevator factory. They can then be easily assembled on-site. This shortens construction period and is effective in safety management and cost reduction. Other examples include preemptive fault detection and smart control technologies utilizing artificial intelligence (Al) and/or the Internet of Things (loT). Furthermore, attempts are being made to expand the technology into future means of transportation, such as urban air mobility (UAM), which the applicant is researching. Thus, elevators are expanding beyond their mere means of transportation within buildings, and are undergoing various technological expansions.

An example of the technology for the modular elevator is Application No. 10-2024-199353, filed by the applicant herein, entitled “Entrance Module, Modular Elevator Including Entrance Module, and Method for Assembling Entrance Module.” This technology introduces a technology for precision assembly of the platform module. Another technology is Application No. 10-2024-0081110, filed by the applicant herein, entitled “Method for Manufacturing a Modular Elevator.” This technology introduces a technology for precision assembly of the rails.

Despite being installed within a building, the elevators are often treated as a separate process from the building itself. Consequently, numerous inconsistencies arise on-site.

### SUMMARY

The prior art has the following technical challenges.

First, the elevator installation process is complex and time-consuming. Specifically, major components such as the elevator rails, doors, and car must be transported individually on-site and assembled sequentially. Furthermore, heavy components must be installed by on-site workers or using auxiliary equipment, resulting in long construction times and significant labor costs.

Second, ensuring installation accuracy is difficult. Specifically, if there are deviations in wall condition or verticality errors during on-site construction, the position alignment and fixing of components will vary each time. Especially in rail installation, even the slightest vertical deviation can significantly impact the precision and operational stability of the entire elevator system.

Third, there's a lack of coordination between the construction company and the elevator manufacturer. Specifically, the construction company only constructs the hoist way and platform, while the elevator company's installation is a completely separate process. Furthermore, the elevator company must perform installation under varying conditions each time, according to the condition after construction is complete. This makes installation consistency and air quality management difficult.

Fourth, it is impossible to integrate with modular construction methods. Specifically, despite the recent modularization of buildings, elevator installation remains stuck in traditional methods. For example, while buildings are precision-engineered steel frames, elevator components are still aligned and installed manually on-site.

Hereinafter, solutions to the technical problems will be described. The first problem of the [technical problem] can be solved by installing a reference structure for fasteners for fixing components to the hoist way wall. The second problem of the [technical problem] can be solved by providing a reference surface for precision assembly, such as a reference position, to provide guidance to workers. The third problem of the [technical problem] can be solved by cooperating with the construction company and the elevator company on the linkage and cooperative design of component installation locations and preliminary structural reflection, and correspondingly, by merging the manufacturing processes between the construction company and the elevator company. The fourth problem of the [technical problem] can be solved by providing a pre-fixing point for the elevator component to be installed accurately in a predetermined location.

The solution to the technical problem is described in more detail.

According to the present disclosure, a method for constructing a building, may include installing a fastener at a reference location which provides a reference for the correct positioning of elevator components within the building, during the construction of the building; providing the elevator components; and fastening the elevator components to the fastener. The providing the elevator components can be done independently of constructing the building.

The elevator component may include at least one of a door module assembly to which at least two door modules are connected, and a rail module to which at least two sub-components providing rails are connected.

The method for constructing a building may further include lifting the elevator components using a lifter installed at the upper end of the hoist way, and then fastening the elevator components to the fastener.

The fastener may be provided in the hoist way.

The first connecting member connecting at least two sub-components providing the rail temporarily assembles the end portions of the sub-components.

The second connecting member connecting the at least two door modules may connect left and right frames of the door modules.

A member to be fastened may be provided on the elevator component, and the member to be fastened and the fastener may be fastened.

According to the present disclosure, a method for installing an elevator may include assembling elevator components providing the elevator into modules at an elevator's production site; installing fasteners for fastening the modules to a building at reference locations within the building which provide as a reference for the correct positioning of the elevator components, during the construction of the building; transporting the modules to the building's construction site; and fastening the modules to the fasteners.

The module may include at least one of a door module assembly to which at least two door modules are connected, and a rail module to which at least two sub-components providing rails are connected.

The method for installing an elevator may further include lifting the module with a lifter installed at the upper end of the hoist way, and then fastening the module to the fastener.

The module may include at least two sub-components providing the module, and a connecting member connecting the at least two sub-components.

The connecting member may connect the at least two sub-components at any one of the production site and the construction site.

According to the present disclosure, an elevator may include a hoist way which is a passage through which a car is raised and lowered in a building; a platform provided at each floor where the car stops; a traction machine provided at an upper portion of the hoist way to raise and lower the car; a counterweight connected to an opposite side of the car by a rope and moving in an opposite direction of the car; a door module provided at the platform to open and close in conjunction with a car door; a rail guiding movement of at least one of the car and the counterweight in a vertical direction; and a fastener fastened to the hoist way to indicate a reference position at which at least one of the door module and the rail is installed.

The door module may include a door frame, and a door suspended from the door frame.

The door frame may include an upper frame on an upper side, a lower frame on a lower side, a left frame on a left side, and a right frame on a right side.

At least two brackets for fastening may be provided at each of the four locations where the upper frame, the lower frame, the left frame, and the right frame meet.

Two fasteners on the upper frame and three or more fasteners on the lower frame may be provided corresponding to the door module.

The door frame may include a bar extending in one direction, and the cross section of the bar may have a [symbol] , ⊏, or [symbol] shape.

The elevator may further include an additional fastener further fastened to the fastener so that at least one of the door module and the rail is fastened to the fastener.

The fastener may include at least one of a stud bolt, a plate, a bar, a bending member, a protrusion, a recess, and a bolt.

At least a portion of the stud bolt may be embedded in a reinforced concrete, corresponding to the building being made of the reinforced concrete.

The plate may be welded to the steel structure and the modular building, corresponding to the building being one of a steel structure and a modular building.

At least two fasteners may be provided in a state of being spaced apart in the vertical direction and at least two fasteners are provided in a state of being spaced apart in the left and right direction for one of the platforms.

According to the present disclosure, a building having an elevator is provided, in order to provide a reference for the correct positioning of components of an elevator in a building, the fastener may be embedded in the building when the building is erected.

The present disclosure may have the following effects. First, the precision of elevator component installation is improved. Second, elevator installation time is shortened and the process is simplified. Third, the required manpower and equipment is reduced. Fourth, post-installation stability and maintenance reliability can be improved.

In particular, for general reinforced concrete or steel structures, first, the matching characteristics of major components such as rails and doors can be improved to match the structure. Second, installation errors can be reduced compared to the prior art.

In particular, modular construction can, firstly, ensure matching in the location of components installed between individual modules. Secondly, the modular construction can significantly improve productivity in module assembly. Thirdly, the overall construction speed can be improved through the interconnected structure between the factory and the construction site.

In addition, the detailed description of the present disclosure may further add to effects thereof.

### BRIEF DESCRIPTION OF THE DRAWINGS

FIG. 1 is a structural drawing illustrating a building and an elevator.

FIG. 2 and FIG. 3 are structural drawings illustrating a building and an elevator, respectively.

FIG. 4 is a perspective view illustrating a portion of a modular building.

FIG. 5(a) and 5(b) are drawings illustrating a fastener provided in a reinforced concrete building, FIG. 5(a) is a drawing illustrating the inside of the hoist way of the reinforced concrete building, and FIG. 5(b) is an enlarged view of b in FIG. 5(a).

FIG. 6 and FIG. 7 are drawings illustrating frames corresponding to one platform, FIG. 6 illustrates a state where the fastener is fastened to the frame, and FIG. 7 illustrates a state where a component of the elevator is fastened to the fastener.

FIG. 8(a)-8(d) are drawings illustrating a method for fastening a fastener, FIG. 8(a) illustrates a bolt (for example, a stud bolt), FIG. 8(b) illustrates a bond (for example, welding), FIG. 8(c) illustrates a protrusion, and FIG. 8(d) illustrates a groove.

FIG. 9 is a flowchart explaining a method of constructing a building.

FIG. 10(a)-10(c) are drawings explaining a method of installing an elevator, FIG. 10(a) is a drawing illustrating a state of installing a door module, FIG. 10(b) is a drawing illustrating a state of installing a rail, and FIG. 10(c) is a drawing illustrating a connection part of the rail.

### DETAILED DESCRIPTION OF THE EMBODIMENTS

Hereinafter, specific embodiments of the present disclosure will be described in detail with reference to the drawings. The idea of the present disclosure is not limited to the following embodiments. Those skilled in the art who understand the idea of the present disclosure can easily propose other embodiments within the same idea by adding, modifying, deleting, or adding elements. However, this also falls within the idea scope of the present disclosure.

The present disclosure may include a plurality of embodiments. A first element of a first embodiment among the plurality of embodiments may be included by adding or modifying elements of another embodiment. A first element of a first embodiment among the plurality of embodiments and a second element of a second embodiment among the plurality of embodiments may be combined to provide another embodiment not specified in the plurality of embodiments.

In the description of the drawings, regardless of the drawing number and symbol, identical or similar elements are given identical or similar reference numbers, and redundant descriptions thereof may be omitted.

The drawings are provided solely to facilitate understanding of embodiments of the present disclosure, and the technical ideas of the present disclosure are not limited by the attached drawings. It should be understood that all modifications, equivalents, or alternatives included within the idea and technical scope of the present disclosure are included.

The suffixes “module” and “part” used in the description of the present disclosure for elements are given or used interchangeably only for the convenience of writing the specification, and may not have a distinct meaning or role in themselves.

In describing the embodiments of the present disclosure, a detailed description of a related known technology may be omitted if it is determined that the detailed description may obscure the gist of the embodiments disclosed in the present specification.

In describing embodiments of the present disclosure, specific examples of related known technologies may be included in the specification. In this case, the technical connection between the known technologies and the present disclosure may be included within the technical idea of the present disclosure.

In the present disclosure, terms including ordinal numbers, such as “first,” “second,” or the like, may be used to describe various elements, but the elements are not limited by the terms. The terms may be used to distinguish one element from other element.

When an element is referred to as being “connected” or “accessed” to another element, it should be understood that it may be directly connected or accessed to other element, but that there may be other elements in between. Conversely, when an element is referred to as being “directly connected” or “directly accessed” to another element, it should be understood that there are no other elements in between.

A singular expression may include a plural expression unless the context clearly indicates otherwise.

In the present disclosure, terms such as “comprises” or “has” are intended to indicate the presence of a feature, number, step, operation, element, component, or combination thereof described in the specification. Therefore, they do not exclude the possibility of the presence or addition of one or more other features, numbers, steps, operations, elements, components, or combinations thereof.

In the present disclosure, if the direction is indicated, a direction of gravity can be defined as a vertical direction. A direction perpendicular to the direction of gravity can be defined as a left and right direction. A direction perpendicular to both the vertical and left and right directions can be defined as the front and rear direction. The front and rear direction can be exemplified by the direction viewed by an observer.

### Example 1

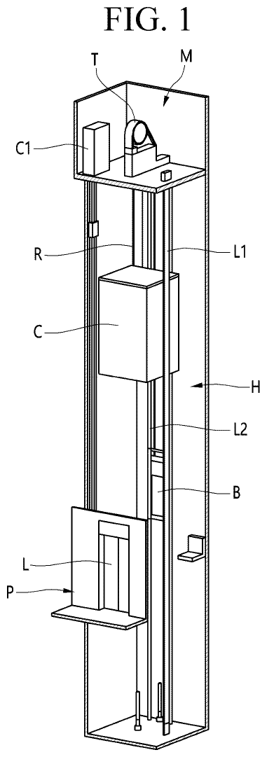

FIG. 1 is a structural drawing illustrating a building and an elevator. See FIG. 1.

### Configuration and Operation of Elevator

An elevator can be installed in a building. Here, the building can be exemplified by a building composed of reinforced concrete. The building can provide a platform, a hoist way, and a machine room to provide the elevator. The platform, the hoist way, and the machine room can form a component of the elevator. The platform P can exemplify an entrance/exit space of each floor where the car C stops. A plurality of platforms can be provided in the building. The hoist way H can exemplify a passage through which the car C is raised and lowered. The machine room M can exemplify a space where components such as a traction machine T and a control module C1 that raise and lower the car C are placed. The machine room M can be provided, for example, above the hoist way H.

A door module L may be provided on the platform. The door module can be opened and closed in conjunction with the door of the car C. The traction machine T can rotate the rope R in both directions. The rope R can be wound around a sheave provided on the output side of the traction machine T. The rope R can extend in both directions with the traction machine as the geometric center. In other words, the rope R is supported by the sheave, and both ends thereof can extend downward by gravity.

The car C may be supported on the first side where the rope extends in one direction. A counterweight B (balance weight) may be supported on the second side where the rope extends in the other direction. The counterweight may compensate for the weight of the car C and the load loaded on the car. The counterweight may reduce energy consumption of the elevator, smoothen the operation of the elevator, and increase the stability of the system. Various methods for connecting the rope R, the car C, and the counterweight B may be provided according to the specifications, use, allowable load, and standards of the building and the elevator. Various methods for connecting the rope R, the car C, and the counterweight B may be included in the idea of the present disclosure.

According to the control of the control module C1, the traction machine T can be selectively driven. By moving the rope R wound around the sheave, the car C can move in the hoist way H in the vertical direction. By moving the rope R wound around the sheave, the car C and the counterweight B can move in the vertical direction. At this time, the car C and the counterweight B can move in opposite directions to each other. The vertical movement of the car C and the counterweight B can be guided by the first rail L1 and the second rail L2.

According to the control of the control module C1, the car C can stop at a specific location. The car C can stop corresponding to a specific platform P. The door of the car C and the door module L of the specific platform can be opened together.

Additional portions may be required for the configuration and operation of the elevator. For example, the counterweight B may also be provided with a sheave around which the rope R is wound. Even if each portion is not described in the present disclosure, the applicant declares that the portions necessary for the configuration and operation of the elevator are included in the present disclosure.

### Composition and Operation of Door Module L of Platform P

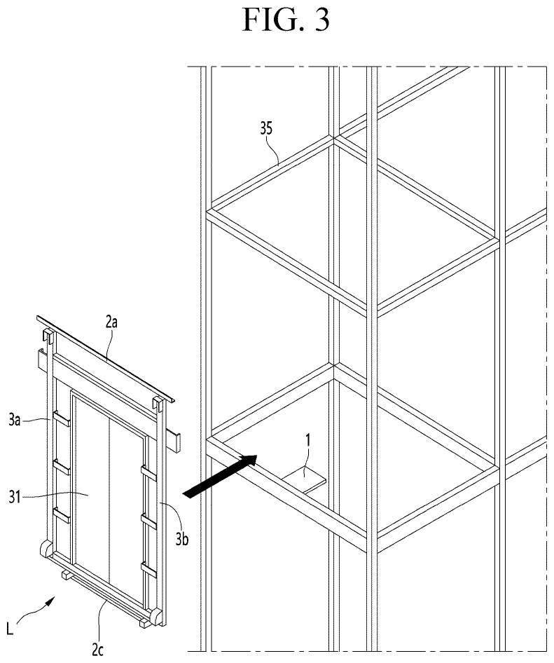

In explaining the configuration of the platform, reference is made to the configuration of the door module L and the surroundings thereof in FIG. 3 together with FIG. 1.

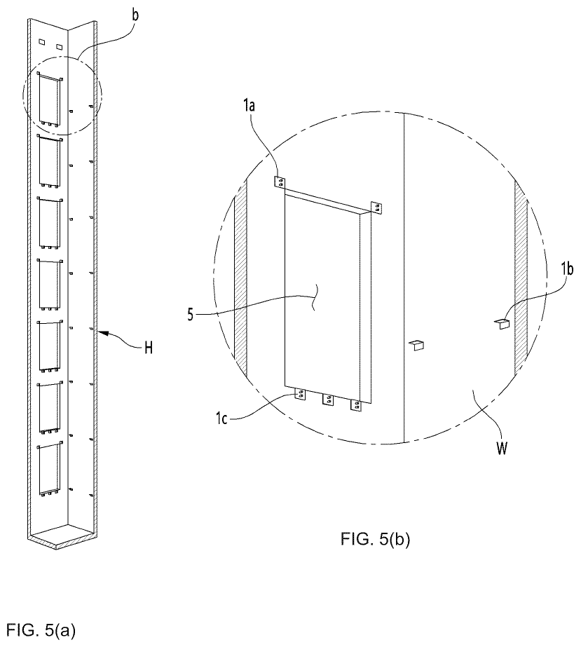

The door module may include a door 31 that opens in a predetermined direction and a door frame on which the door is supported. The door frame may be installed corresponding to an opening (see 5 in FIG. 5(a) and 5(b)). The door frame may include upper and lower frames (for example, sills) 2 on the upper and lower sides, and left and right frames (for example, jambs) 3 on the left and right sides. The upper and lower frames 2 may fix the left and right frames 3. The left and right frames 3 may be fastened to the upper and lower frames 2. The material of the bar providing the door frame may be iron or stainless steel. The bar providing the door frame may extend in one direction. The bar may be provided by fastening at least two bars. The cross-section of the bar may have at least one bent part. The cross-section of the bar may be provided in a rectangular shape. The cross-section of the bar may be provided in a hollow rectangular shape. The cross-section of the bar may be provided as a hollow rectangle with one edge removed. The cross-section of the bar may be provided as a hollow rectangle with two consecutive edges removed.

The cross-section of the bar may include at least one bar having an [symbol] , ⊏, or [symbol] shape. The cross-section of the bar providing at least one of the upper and lower frames or the upper frame of the upper and lower frames may have an [symbol] , ⊏, or [symbol] shape.

The door frame may include an upper frame 2a on the upper side (observed from the platform), a lower frame 2c on the lower side, a left frame 3a on the left side, and a right frame 3b on the right side. Brackets for fastening may be provided at four locations where the upper frame 2a, the lower frame 2c, the left frame 3a, and the right frame 3b meet each other. Here, the brackets may be referred to as a coupling structure. The coupling structure may include four coupling structures spaced apart from each other. Accordingly, the frame may be maintained firmly. For example, at least two fastening brackets that are connected to each other may be provided at four locations connecting the end portions of the upper and lower frames and the left and right frames, respectively.

In the door frame, the coupling structures for fastening at four locations may be provided symmetrically with each other. For example, the first, second, third, and fourth coupling structures may all be formed identically. However, the second coupling structure may be formed symmetrically with the first coupling structure in the X-axis direction, the third coupling structure may be formed symmetrically with the first coupling structure in the Z-axis direction, and the fourth coupling structure may be formed symmetrically with the first coupling structure in the diagonal direction between the X-axis and the Z-axis. Accordingly, the universality of the components may be improved and inventory costs may be reduced.

The door frame may allow movement of the door. For this purpose, the door 31 may be suspended from the door frame. The door frame may guide the door. For this purpose, the door frame may be provided with a recess into which the peripheral portion the door is inserted and/or guided.

### Configuration and Operation of Rails L1 and L2

The rails L1 and L2 can be installed to extend vertically from the inner surface of the hoist way H. The rails L and L2 can be fastened to the inner surface of the hoist way H. The rails L and L2 can be directly fastened to the inner surface of the hoist way H using a single type of fastener or indirectly fastened using two or more types of fasteners. The rails L and L2 can guide the vertical movement of the car C and the counterweight B. The rails can prevent the car C and the counterweight B from swinging in the left and right direction and in the front and rear direction. The rails can have a plurality of sub-components connected vertically. The sub-components can refer to sub-components that form a component of the elevator. For example, a rail part of a predetermined length that provides a component as a single rail that is a component of the elevator can be referred to as a sub-component with respect to the single rail. The same applies hereinafter.

If the alignment of the sub-components is misaligned, problems such as vibration may occur during elevator operation. Furthermore, once the rail is fixed, it is difficult to adjust the alignment of the rail even if an error in the alignment of the rail is confirmed due to the amplified joint tolerance between a plurality of sub-components. As a technology to resolve this, the applicant's prior art application No. 10-2024-0081110, entitled “Method for Manufacturing a Modular Elevator,” discloses a fish plate, a clip member, and a fixing block for aligning. Precisely fixing the rail to the reference position can be said to be one of the core technologies in the field of elevator technology.

### Reference Position Structure

The present disclosure may include a structure that provides a reference position for components of an elevator in a building. The structure may be provided at the reference position. Here, the reference position may refer to a reference for the correct position of components of the elevator for proper operation of the elevator. The reference position may refer to a reference point or surface for installation of rails, door modules, or the like, preset to meet the safety operation and design specifications of the elevator. The reference position may refer to a location that provides a reference for the correct installation of components of the elevator. For example, for installation of one of the components of the elevator in the building, it may be necessary to fasten the component to the building at ten locations. In this case, the structure providing the reference position may be provided at at least two of the ten locations. Of course, the structure may be installed at more locations, such as the ten locations. The reference position may be determined in advance through cooperation between the construction company and the elevator company. The reference position may be indicated on the design drawing for the construction of the building.

For example, as the structure, a fastener 1 may be provided on the inner surface of the hoist way H of the building. Although one fastener is illustrated in the drawing, a plurality of fasteners may be provided in a required number and position. The fastener may directly or indirectly provide at least one of a reference position, a reference surface, a reference point, a fastening point, and a fastening surface for a component of the elevator. At least one of the rails L1, L2 and the door module L may be fastened to the fastener 1. At least one of the rail L1, L2 and the door module L may be fastened to the fastener 1, either directly or indirectly. The rail L1, L2 may be indirectly fastened to the fastener 1. The door module L may be directly fastened to the fastener 1.

The fastener 1 may include at least one of a bolt, a stud bolt, a frame, a bent frame, and a bracket having at least two faces. Preferably, it may include the stud bolt.

At least a portion of the fastener 1 may be embedded within the interior of the reinforced concrete structure. At least a portion of the fastener 1 may be embedded within the structure. The fastener 1 may include a portion embedded within the interior structure of the building. The embedded portion may be designed in advance during the design of the building and installed during the construction of the building. For example, the fastener 1 may be provided within the formwork when the formwork for the reinforced concrete is provided. The fastener 1 may be incorporated into the building in advance during the curing of the reinforced concrete. The fastener 1 may be firmly integrated with the building. The location, structure, and method for installing the fastener 1 may be determined in advance through cooperation between the construction company and the elevator company. Therefore, it may be reflected in the design drawings of the building.

By fastening the components of the elevator to the fastener 1, the components of the elevator can be disposed at the correct position. The fastener 1 can be provided at the reference position during the construction of the building. In other words, the fastener 1 can be disposed at the reference position from the beginning (from the time of building construction). Accordingly, each part of the elevator can be disposed accurately at the correct position. The sub-components providing each component of the elevator can also be disposed accurately at the correct position. Accordingly, from the beginning, misalignment between the sub-components providing each component of the elevator can be prevented. The correct position of the rail can be further improved. Accordingly, the technology of the applicant's prior art application No. 10-2024-0081110, ‘A Method for Manufacturing a Modular Elevator’, may not be required. Of course, the application of the applicant's alignment technology may not be excluded.

The present disclosure can achieve various technical aspects presented in the technical problems and effects of the present invention by the fastener.

### Example 2

The present example illustrates an elevator without a machine room M. Portions similar to those of the first embodiment will be omitted, and other portions will be described with emphasis. Additional portions may be required for the configuration and operation of the elevator without a machine room. For example, even without the machine room, a frame for installing a traction machine may be included. Even if each portion is not described in the present disclosure, the applicant declares that the portions necessary for the configuration and operation of the elevator are included in the present disclosure.

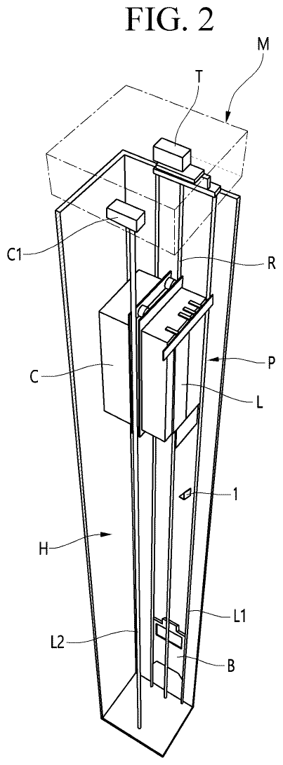

FIG. 2 and FIG. 3 are structural drawings illustrating a building and an elevator, respectively. See, FIG. 2 and FIG. 3.

The door module L can be fastened to the frame 35 of each module that provides an elevator without the machine room M. The frame 35 can be installed on each floor where the car stops. The frame 35 can be disposed at a position corresponding to the car door of the car C that stops on each floor.

The frame 35 may be a steel beam forming a steel structure. The frame 35 may be a beam. The beam may be structural steel having various cross-sectional shapes. The beam 35 of the steel structure may be an H-beam, an I-beam, a C-beam, or the like. The beams may be connected to each other to provide a building. Here, the building may be a steel structure building. Here, the steel structure may refer to a structure that provides a structure that supports the load of the building with steel. For example, the steel structure may provide columns, trusses, and beams for the building all with steel beams. This is different from reinforced concrete that is used together with concrete. The frame may be a steel beam of each module that provides the modular elevator.

The beam 35 may be fastened with a fastener 1 at the reference position defining the installation position of each elevator component. The fastener may be fastened by welding and bolting. The fastener may be a bracket for fastening each elevator component. The fastener may include at least one of a reference point, a reference position, a reference surface, and a fixing means (for example, a screw hole, a guide pin insertion portion, and a protrusion, or the like) for installation of each component. At least one of the rails L1, L2 and the door module L may be fastened to the fastener 1. The rail L1, L2, the door module L, or the like may be pre-assembled at a production site and then moved to a construction site.

The rails L1, L2, the door module L, or the like may be designed to be matched to the correct position of the fastener 1. Here, the matching may include matching of the components, matching of the sub-components providing the components, and matching when using a member (for example, a chain) connecting at least two of the sub-components.

In the steel structure, the installation location of the fastener 1 can be precisely disposed at the reference position of the beam 35. For example, accuracy down to the millimeter can be ensured through metal-to-metal fastening. Accordingly, the advantages of the present disclosure can be further enhanced.

### Example 3

The present example demonstrates a modular building. This modular building is a building constructed by prefabricating building units (modules) at a modular factory, transporting them to the site, and assembling them. This modular building offers the advantages of shortened construction periods, reduced construction costs, consistent quality, reduced waste, reduced on-site pollution, and reusability. The same portions as in the first and second embodiments will be omitted, and the description will focus on the different portions.

Even for the modular building described above, additional components may be required for the configuration and operation of the elevator. For example, the door module L and the car C may naturally be included. Even if each of these components is not described in the present disclosure, the applicant declares that the components necessary for the configuration and operation of the elevator are included in the present disclosure.

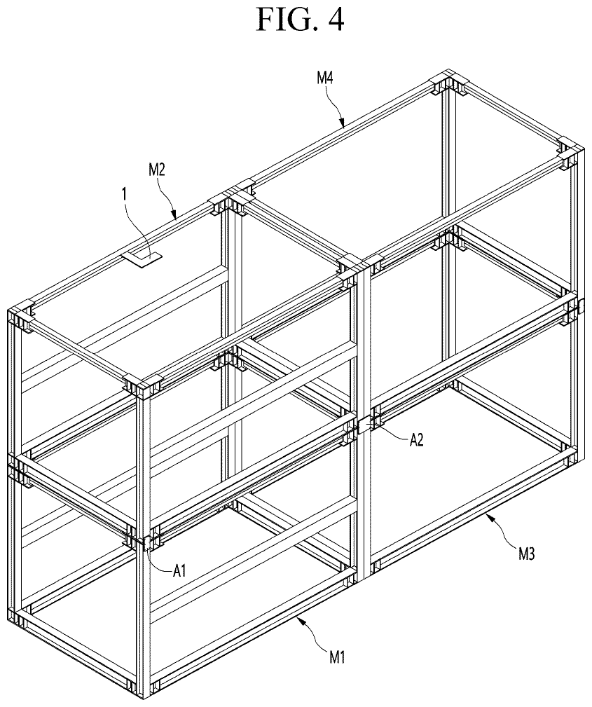

FIG. 4 is a perspective view illustrating a portion of a modular building. See FIG. 4.

As components for providing the modular building, building modules M1 to M4 are provided. The building modules may include a first module M1, M2 that provides the hoist way H, and a second module M3, M4 that is not related to providing the hoist way H. Each of the building modules may be strongly fastened by building module fastening members A1, A2. The building module fastening members A1, A2 may have a load capacity sufficient to withstand the load of the building.

The fastener 1 may be fastened to a frame or beam 35 providing the building module. Specifically, when manufacturing the building module, the reference position for installing each component of the elevator can be secured in each of the first modules M1, M2. The fastener 1 may be fastened or inserted in advance at the factory in accordance with the reference position. The fastener may provide the reference position. Each component of the elevator may be fastened to the fastener 1. When at least two of the first modules are coupled, matching between each component of the elevator can be achieved naturally.

The present example allows for both modularization of the building and modularization of the elevator. This greatly enhances the advantages of utilizing modular building. In particular, the installation of the elevator and the modular construction can be performed simultaneously. Furthermore, the present example offers the advantage of high matching between each component.

### Example 4

The present example specifically presents an embodiment in which the fastener 1 is provided in the reinforced concrete building of the first embodiment.

FIG. 5(a) and 5(b) are drawings illustrating a fastener provided in a reinforced concrete building. FIG. 5(a) is a drawing illustrating the inside of the hoist way of the reinforced concrete building, and FIG. 5(b) is an enlarged view of b in FIG. 5(a). See FIG. 5(a) and 5(b).

The reinforced concrete building is provided with a wall W. The wall may be provided with both reinforcing steel and concrete. The wall may provide the hoist way H. In the hoist way H, an opening 5 connected to the platform P may be provided. The wall W may be opened to provide the opening 5. The door module L may be provided in the opening 5. The door module L may be fastened to a peripheral portion of the wall W adjacent to the opening 5. The door module may be fastened to an inner surface of the wall. The fastener 1 may be provided for fastening the door module.

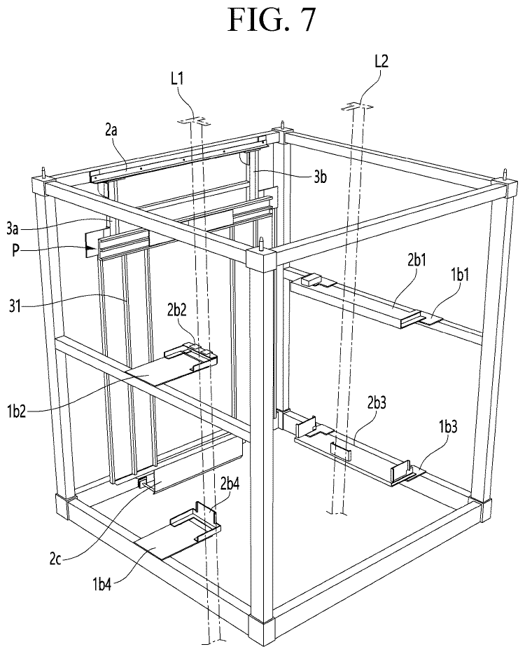

The fastener 1 for fastening the door module L may be referred to as the first fastener. A plurality of the first fasteners may be provided. For example, the first fastener may include an first upper fastener 1a for fastening an upper frame (see 2a of FIG. 7) among the upper and lower frames 2, and a first lower fastener 1a for fastening a lower frame (see 2c of FIG. 7) among the upper and lower frames 2.

The first upper fasteners 1a may be provided in two pieces spaced apart from each other. The first upper fasteners 1a may be disposed adjacent to the apex of the opening. The first upper fasteners 1a may be installed beyond the range in the left and right direction in which the opening 5 is formed. Accordingly, the reference position can be guided as accurately as possible. The first lower fasteners 1a may be provided in three pieces spaced apart from each other. The first lower fasteners 1c may be disposed along the lower edge of the opening 5. The first lower fasteners 1c may be installed within the range in which the opening 5 is formed in the left and right direction. Accordingly, the weight of the door module L and/or the lower frame 2c can be firmly supported. The left and right frames 3 may be supported by the upper and lower frames 2.

The present disclosure may not exclude the provision of a separate fastener 1 for guiding the correct position of the left and right frames 3. However, it may be preferable to provide fasteners for the upper and lower frames 2 for safe guidance of the door module. The entire or each spacing in the left and right directions where the first upper fastener is installed may be greater than the entire spacing in the left and right directions where the first lower fastener is installed. Accordingly, the door module can be safely supported.

A fastener 1 that fastens at least one of the first rail L1 and the second rail L2 may be referred to as a second fastener 1b. A plurality of second fasteners may be provided. The second fastener may be provided on a surface different from the surface of the wall W on which the first fastener is installed. Here, the other surface may be a surface facing the surface having the opening or a surface intersecting in the left and right direction or front and rear direction.

The second fasteners 1b may be provided spaced apart from each other in the left and right direction on the inner surface of the wall W. The second fasteners 1b may be provided spaced apart from each other in the vertical direction on the inner surface of the wall W. The two spaced apart second fasteners 1b may together guide the correct position of a component of the elevator. For example, the first rail (the rail guiding the car) may be guided to the correct position by at least two second fasteners 1b spaced apart from each other in the vertical direction. For example, the second rail (the rail guiding the counterweight) may be guided to the correct position by at least two second fasteners 1b spaced apart from each other in the left and right direction. The second rail may be guided to the correct position by at least two second fasteners 1b spaced apart from each other in the left and right direction. The drawing illustrates two second fasteners 1b spaced apart in the left and right direction.

### Example 5

The present example illustrates a specific embodiment in which the fastener 1 is provided in the frame of the second embodiment and the third embodiment. The frame may include the steel structure, the module of the modular elevator, and the metal beam of the modular building. The fastener disclosed in the fourth embodiment is applied to the same description and thus the description thereof is omitted.

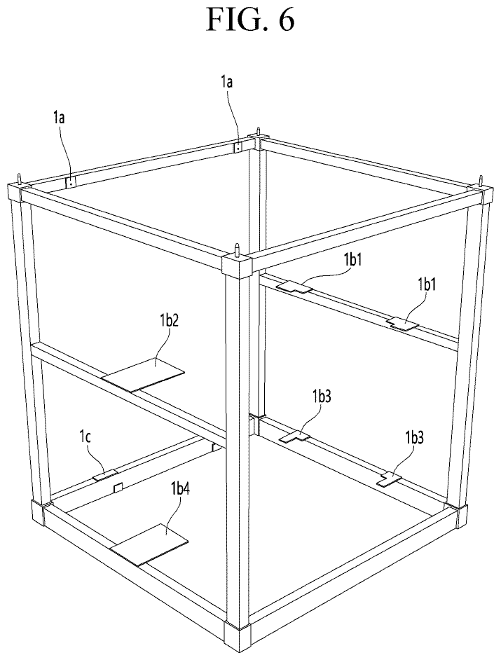

FIG. 6 and FIG. 7 are drawings illustrating frames corresponding to one platform, FIG. 6 illustrates a state where the fastener is fastened to the frame, and FIG. 7 illustrates a state where a component of the elevator is fastened to the fastener. See FIG. 6 and FIG. 7.

The first fastener 1a, 1c may be provided on the frame providing the opening 5. The upper and lower frames 2 providing the door module L may be fastened to the first fastener 1a, 1c. The left and right frames 3a, 3b providing the door module L may be fastened to the upper and lower frames 2. A door 31 providing the door module L may be assembled to the upper and lower and left and right frames 2, 3. It can be understood that the door is opened and closed.

The second fastener 1b may be provided on one surface of the wall on which the rail L1, L2 is installed.

In order to guide the first rail L1 (the rail guiding the car), at least two second fasteners 1b2, 1b4 guiding the car, spaced apart from each other in the vertical direction, may be provided. The second fasteners 1b2, 1b4 guiding the car may be provided on different frames spaced apart from each other in the vertical direction. The sub-component providing the first rail may be directly fastened to the second fasteners 1b2, 1b4 guiding the car. The first attachment component 2b2, 2b4 supporting the first rail L1 may be fastened to the second fasteners 1b2, 1b4 guiding the car. The sub-component providing the first rail may be fastened to the first attachment component. The sub-component providing the first rail can be indirectly fastened to the second fastener 1b2, 1b4 Guiding the Car.

In order to guide the second rail L2 (the rail guiding the counterweight), at least two second fasteners 1b1 for guiding the counterweight, spaced apart in the left and right direction, may be provided. In order to guide the second rail L2, at least two second fasteners 1b1, 1b3 for guiding the counterweight, spaced apart in the vertical direction, may be provided. The second fasteners 1b1, 1b3 for guiding the counterweight may be provided on different frames and/or the same frame spaced apart in the vertical direction. A sub-component providing the second rail may be directly fastened to the second fasteners 1b1, 1b3 for guiding the counterweight. A second attachment component 2b1, 2b3 supporting the second rail L2 can be fastened to the second fastener 1b1, 1b3 guiding the counterweight. The sub-component providing the second rail can be fastened to the second attachment component 2b1, 2b3. The sub-component providing the second rail can be indirectly fastened to the second fastener 1b1, 1b3 guiding the counterweight.

The second attachment component 2b1, 2b3 may further be provided with a portion supporting the first rail L1. For example, the second attachment component may further have a portion supporting the first rail L1 at an end portion adjacent to the center of the hoist way H. This structure may be preferably applied when the first and second rails face each other.

### Example 6

The present example is an embodiment that specifies that the fastener is fastened to a building in the first to fifth examples.

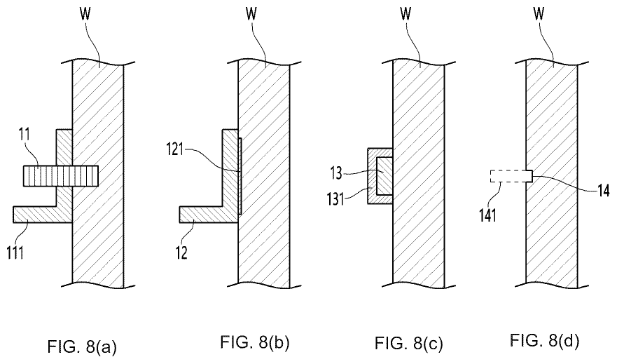

FIG. 8(a)-8(d) are drawings illustrating a method for fastening a fastener. FIG. 8(a) illustrates a bolt (for example, a stud bolt), FIG. 8(b) illustrates a bond (for example, welding), FIG. 8(c) illustrates a protrusion, and FIG. 8(d) illustrates a groove. See FIG. 8(a)-8(d).

A predetermined bar 11 may be inserted into a wall W of a building. The bar 11 may be a bolt or a stud bolt. In this case, the building may be a reinforced concrete building. At least a portion of the bar may be embedded in concrete. The bar may be in contact with the reinforcing steel. At least a portion of the bar may protrude outside the wall at a precise position (the reference position) of the wall. The bar 11 may be the fastener 1. An additional fastener 111 may be further installed in the wall. The additional fastener 111 may fix the attachment component. The additional fastener 111 may provide a fastening surface for stably fixing other components.

A predetermined bent member 12 may be fastened to the wall W. The bent member 12 may be, for example, a bracket. In this case, the building may be a steel structure or a modular building. The bent member 12 may have one surface fastened to the wall. The bent member 12 may be fastened by welding. The bent member 12 may be the fastener 1. An adhesive part 121 may be provided at a contact part between the bent member 12 and the wall W. The adhesive part may include a fusion part or a welded part.

A predetermined protrusion 13 may be provided on the wall W. The protrusion 13 may be a portion protruding from the wall. The protrusion 13 may be the fastener 1. A component of the elevator may be fastened to the protrusion 13. The component of the elevator may include a holding part 131 that holds and fixes the protrusion. Any fastening method, such as welding, riveting, or bolting, may be applied to the fastening method between the protrusion 13 and the holding part 131. In addition to such direct fastening, a connecting component may be further provided between the component of the elevator and the protrusion.

A predetermined recess 14 may be provided in the wall W. The recess 14 may be a recessed portion in the wall. The recess 14 may be the fastener 1. A component of the elevator may be fastened to the recess 14. The component of the elevator may include an insertion portion 141 that is fitted into and fixed to the recess. Any fastening method, such as welding, expansion, or twisting, may be applied to the fastening method of the recess 14 and the insertion portion 141. In addition to such direct fastening, a connecting component may be additionally provided between the component of the elevator and the protrusion. The protrusion and the recess may be applied regardless of the type of building.

### Example 7

The present example is an embodiment that specifies a method for installing the elevator and building of the above-described example. The devices of the first to sixth examples can be applied to the application of the present method.

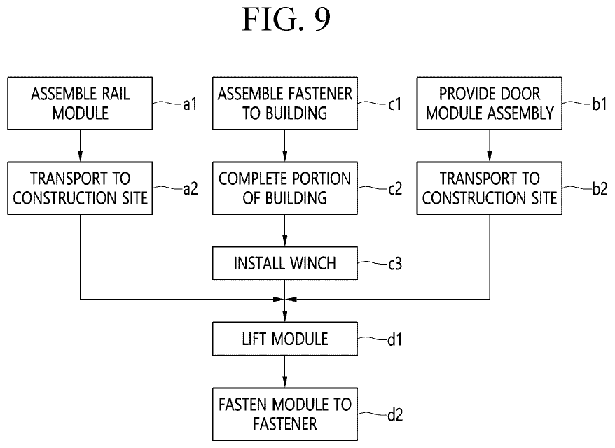

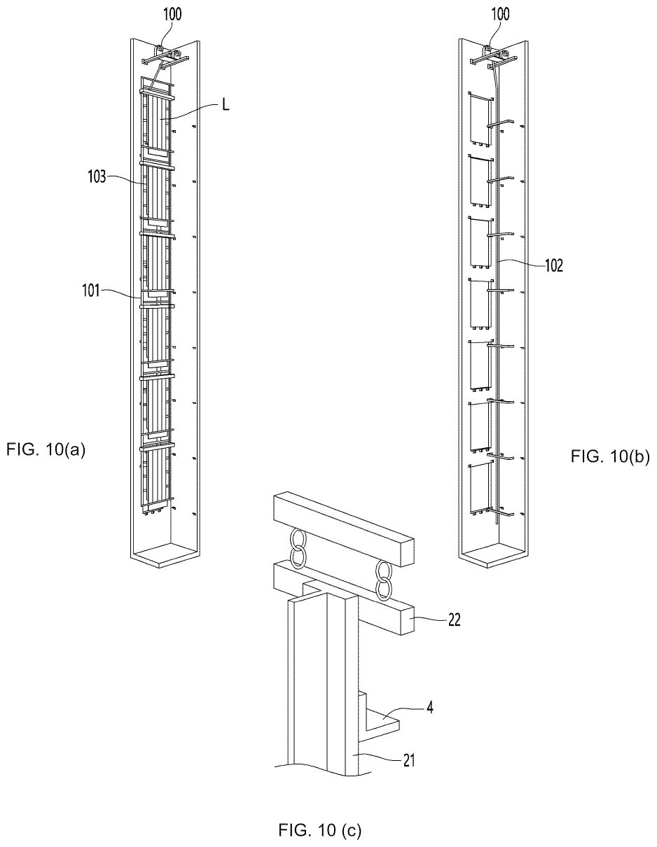

FIG. 9 is a flowchart explaining a method of constructing a building. FIG. 10(a)-10(b) are drawings explaining a method of installing an elevator, FIG. 10(a) is a drawing illustrating a state of installing a door module, FIG. 10(b) is a drawing illustrating a state of installing a rail, and FIG. 10(c) is a drawing illustrating a connection part of the rail.

First, see FIG. 9. A rail module providing the rail is assembled at a production site (a1). The rail module (see 102 of FIG. 10(a)-10(c)) may be in a state where the sub-components forming the rail are connected to each other. Here, the connected state may be a state where the sub-components forming the rail are temporarily assembled to each other. Regardless of the rail module, a door module assembly may be provided (b1). In the door module assembly, at least two of the door modules may be connected to each other by a connecting member. Here, the connected state may be a state where the sub-components forming the door module assembly are temporarily assembled to each other.

The fastener can be assembled to a building component independently of the door module assembly and the rail module (c1). In the above step, “independent” can mean at least one of the following: manufacturing independently of each other, having separate production sites from each other, having different production times, and operating in conjunction with each other. Of the rail module and the door module assembly, only one can be applied with the method according to the present disclosure.

Once construction of the building part is completed, installation of the elevator can be commenced (c2). In this state, a lifter can be installed at the upper end of the hoist way (c3). Here, the lifter can be a lifting device such as a winch or traction machine.

The rail module and the door module assembly can be transported to a construction site (a2) (b2). Thereafter, at least one of the rail module and the door module assembly can be lifted into the interior of the hoist way by the lifter (d1). At least one of the rail module and the door module assembly can be fastened to the fastener 1. It should be noted that, by fastening at least one of the rail module and the door module assembly to the fastener, the fastening can be completed without the need for a process of position alignment, matching, or correction. In other words, fastening at least one of the rail module and the door module assembly to the fastener can ensure installation in the correct position. This is because the fastener can be installed at an accurate location in the building.

Referring to FIG. 10(a)-10(c). The door module assembly 103 will be described. The door modules L may be provided individually for each opening 5. The door modules L may be connected to each other by a second connecting member 101 to provide an assembly 103 of the door modules. The second connecting member 101 may be connected to the left and right frames 3 of the door module. The second connecting member 101 may be connected to the left and right end portions of the door module. Therefore, the center of gravity of the door module in the left and right direction can be smoothly controlled. Here, the second connecting member 101 may be a chain. Here, the chain may refer to a chain structure made of a metal material. The chain may include a pin-hinge connecting structure. The second connecting member 101 may connect adjacent door modules so that they can move to each other. The second connecting member may be temporarily assembled to the door module. For example, the second connecting member may be temporarily assembled using bolts. The bolts may be removed later. The door module assembly may be folded at the production site to reduce the volume thereof. For example, the door module assembly may be loaded onto a truck after being produced at the production site. The door module assembly may be conveniently transported to the construction site. After being transported, the door module assembly may be lifted and installed by the lifter 100.

When the door module assembly 103 is lifted, each door module can be unfolded. For example, the door module, which was folded, can be unfolded in a long manner while being connected by the second connecting member. The unfolded door module can be introduced and lifted into the interior of the hoist way. The second connecting member can also be connected to each sub-component when the door module assembly is lifted.

After the door module assembly 103 is lifted, each door module can be fastened to the fastener 1. Fastening can be performed by sequentially fastening the rail modules from the lower end to the upper side. This is to separate the connected state of each door module L forming the door module assembly. In other words, the door module assembly placed above the door module being fastened is to maintain the connected state. The fastening may include fastening the fastener 1 and the door module L to each other, and separating or releasing the second connecting member 101 from the door module L.

The rail module 102 will be described. The sub-components 21 forming the rails L1, L2 can be connected and extend in the vertical direction. A first connecting member 22 can be provided at the connecting part of the sub-components. Here, the connecting part can be an end portion of the sub-components. The first connecting member can connect the parts so that they can move with each other. The first connecting member can be temporarily assembled to the sub-components. For example, the first connecting member can be temporarily assembled using bolts. The bolts can be removed later. The first connecting member can be provided in a bendable chain structure. The rail module can be folded at the production site to have a reduced volume. For example, the rail module can be loaded onto a truck after being produced at the production site. The rail module can be conveniently transported to the construction site. After being transported, the rail module can be lifted and installed by the lifter 100.

When the rail module 102 is lifted, each sub-component of the rail can be unfolded. For example, the sub-component that was folded can be unfolded in a long manner while being connected by the first connecting member. The unfolded sub-component can be introduced and lifted into the interior of the hoist way. The first connecting member can also be connected to each sub-component when the rail module is lifted.

After the rail modules 102 are lifted, each module can be fastened to the fastener 1. At this time, the fastening can be performed by sequentially fastening the rail modules from the lower end to the upper side. The purpose is to separate the sub-components of the rail module on the upper side of the sub-component being separated from the lower end while in a connected state. Here, the fastening can include fastening the fastener 1 and the member to be fastened 4 to each other, and separating or releasing the first connecting member 22 from the sub-component 21. The member to be fastened can be provided at an spacing of approximately 2 meters or more in the vertical direction.

### INDUSTRIAL APPLICABILITY

The present disclosure may provide various advantages to elevators and buildings having such elevators.

What is claimed is:

1. A method for constructing a building, comprising:
installing a fastener at a reference location which provides a reference for the correct positioning of elevator components within the building, during the construction of the building;
providing the elevator components; and
fastening the elevator components to the fastener.

2. The method for constructing a building of claim 1,
wherein the elevator component includes at least one of a door module assembly to which at least two door modules are connected, and a rail module to which at least two sub-components providing rails are connected.

3. The method for constructing a building of claim 2, further comprising:
lifting the elevator components using a lifter installed at the upper end of the hoist way, and then fastening the elevator components to the fastener.

4. The method for constructing a building of claim 3, wherein the fastener is provided in the hoist way.

5. The method for constructing a building of claim 2,
wherein the first connecting member connecting at least two sub-components providing the rail temporarily assembles the end portions of the sub-components, and
wherein the second connecting member connecting the at least two door modules connect left and right frames of the door modules.

6. The method for constructing a building of claim 1, wherein a member to be fastened is provided on the elevator component, and the member to be fastened and the fastener are fastened.

7. A method for installing an elevator comprising:
assembling elevator components providing the elevator into modules at an elevator's production site;
installing fasteners for fastening the modules to a building at reference locations within the building which provide as a reference for the correct positioning of the elevator components, during the construction of the building;
transporting the modules to the building's construction site; and
fastening the modules to the fasteners.

8. The method for installing an elevator of claim 7, wherein the module includes at least one of a door module assembly to which at least two door modules are connected, and a rail module to which at least two sub-components providing rails are connected.

9. The method for installing an elevator of claim 7, further comprising:
lifting the module with a lifter installed at the upper end of the hoist way, and then fastening the module to the fastener.

10. The method for installing an elevator of claim 7,
wherein the module includes at least two sub-components providing the module, and a connecting member connecting the at least two sub-components, and
wherein the connecting member connects the at least two sub-components at any one of the production sites and the construction site.

11. An elevator comprising:
a hoist way which is a passage through which a car is raised and lowered in a building;
a platform provided at each floor where the car stops;
a traction machine provided at an upper portion of the hoist way to raise and lower the car;
a counterweight connected to an opposite side of the car by a rope and moving in an opposite direction of the car;
a door module provided at the platform to open and close in conjunction with a car door;
a rail guiding movement of at least one of the car and the counterweight in a vertical direction; and
a fastener fastened to the hoist way to indicate a reference position at which at least one of the door modules and the rail is installed.

12. The elevator of claim 11,
wherein the door module includes a door frame, and a door suspended from the door frame,
wherein the door frame includes an upper frame on an upper side, a lower frame on a lower side, a left frame on a left side, and a right frame on a right side, and
wherein at least two brackets for fastening are provided at each of the four locations where the upper frame, the lower frame, the left frame, and the right frame meet.

13. The elevator of claim 12, wherein two fasteners on the upper frame and three or more fasteners on the lower frame are provided corresponding to the door module.

14. The elevator of claim 12,
wherein the door frame includes a bar extending in one direction, and
wherein the cross section of the bar has a 1, E, or o shape.

15. The elevator of claim 11, further comprising:
an additional fastener further fastened to the fastener so that at least one of the door modules and the rail is fastened to the fastener.

16. The elevator of claim 11, wherein the fastener includes at least one of a stud bolt, a plate, a bar, a bent member, a protrusion, a recess, and a bolt.

17. The elevator of claim 16, wherein at least a portion of the stud bolt is embedded in a reinforced concrete, corresponding to the building being made of the reinforced concrete.

18. The elevator of claim 16, wherein the plate is welded to the steel structure and the modular building, corresponding to the building being one of a steel structure and a modular building.

19. The elevator of claim 11, wherein
at least two fasteners are provided in a state of being spaced apart in the vertical direction and
at least two fasteners are provided in a state of being spaced apart in the left and right direction for one of the platforms.

20. A building having an elevator, wherein, in order to provide a reference for the correct positioning of components of an elevator in a building, a fastener provided in the elevator of claim 11 is embedded in the building when the building is erected.
